(19) United States
(12) Patent Application Publication
(10) Pub. No.: US 2017/0066195 A1
(43) Pub. Date: Mar. 9, 2017

(54) METHOD AND APPARATUS FOR 3D PRINTING OF OBJECT LARGER THAN PRINTING AREA

(71) Applicant: ELECTRONICS AND TELECOMMUNICATIONS RESEARCH INSTITUTE, Daejeon (KR)

(72) Inventors: Chang-Woo CHU, Daejeon (KR); Kap-Kee KIM, Daejeon (KR); Chang-Joon PARK, Daejeon (KR); Jin-Sung CHOI, Daejeon (KR)

(21) Appl. No.: 15/198,616

(22) Filed: Jun. 30, 2016

(30) Foreign Application Priority Data
Sep. 7, 2015 (KR) 10-2015-0126228

(51) Int. Cl. B29C 67/00; G05B 19/4099; B33Y 50/02; B33Y 10/00; B33Y 30/00

(52) U.S. Cl. CPC B29C 67/0088; B29C 67/0051; B29C 67/0092; B33Y 10/00; B33Y 30/00; B33Y 50/02; G05B 19/4099; G05B 2219/49019

(57) ABSTRACT

A method for 3D printing of an object that is larger than the printing area of a 3D printer and a device using the method. The 3D printing method includes receiving 3D mesh data of the object, determining whether the 3D mesh data is included in the printing area of the 3D printer, generating partitioned mesh objects by partitioning the 3D mesh data if the 3D mesh data is not included in the printing area of the 3D printer, forming a connector for connecting the partitioned mesh objects, arranging the partitioned mesh Objects in the printing area, and printing the arranged partitioned mesh objects in 3D.

### CROSS REFERENCE TO RELATED APPLICATION

This application claims the benefit of Korean Patent Application No. 10-2015-0126228, filed Sep. 7, 2015, which is hereby incorporated by reference in its entirety into this application.

### BACKGROUND OF THE INVENTION

1. Technical Field

The present invention relates generally to a 3D printing method and apparatus and, more particularly, to technology for 3D printing an object that is larger than a printing area of a 3D printer.

2. Description of the Related Art

3D printing technology is a series of techniques that are necessary in order to create a real-world object having a physical form from a digital model produced in 3D. The conventional mechanical manufacturing method uses subtractive manufacturing, by which a shape is constructed by successively cutting material away from a solid block of raw material, whereas 3D printing uses additive manufacturing, by which a product is made by depositing successive layers of powder, liquid, or solid material.

3D printing has been mainly used in order to manufacture prototypes of products, but the field of application thereof has broadened thanks to technical improvements, increased economic feasibility, and the like. Also, with the dissemination of 3D printers, 3D printing is expanding to application fields aimed at general users. Specifically, 3D printing is applied to various industrial fields such as consumer goods, electronics, automotives, medical and dental industries, industrial machines, office machines, aerospace, and the like, and is mainly used for manufacturing functional components. Also, recently, as it is used for producing prostheses, artificial organs, and the like in the medical field, the development of related technology and the expansion of the market are expected.

Generally, 3D printing comprises a modeling process for designing a product, a printing process for making a 3D object by depositing digitalized models, and post-processing for polishing or dyeing the surface. In 3D printing, because the final product is produced by depositing layers of material, the final product can be acquired without an assembly process.

Also, 3D printing is advantageous in small quantity batch production, makes it easy to create a product having a complicated shape, and enables the production of various products using a single apparatus. Also, it may reduce the cost and time required to manufacture prototypes.

On the other hand, 3D printing has disadvantages in that it takes a longer time to produce common products and in that the surface of the products may have low precision. Also, because a 3D printer has a fixed printing area, it is difficult to print an object larger than the printing area.

In order to solve the limitation of the printing area in 3D printing, the printable area of a 3D printer may be expanded. In this case, a large 3D object can be printed without using dedicated 3D computer graphics software, but there are problems related to the price of the 3D printer and space for installation of the printer.

Also, because the 3D printer having an expanded printing area is difficult to use for general purposes, a method in which a 3D object to be printed is partitioned into parts and the parts are printed and assembled is being researched. This method requires a process of partitioning a 3D object into multiple parts and a process of forming the multiple parts with a 3D mesh structure for enabling 3D printing. Here, the process of partitioning a 3D object into multiple parts can be performed using dedicated 3D computer graphics software.

However, it is difficult to learn how to use dedicated 3D computer graphics software, and a large number of operations must be performed manually. Also, in order to check whether the partitioned parts can be included in the printing area of the 3D printer, additional software must be used.

In connection with this, Korean Patent No, 10-1533374 discloses a technology related to “DLP-type 3D printer” on Jul. 2, 2015.

### SUMMARY OF THE INVENTION

An object of the present invention is to provide a 3D printing apparatus that may automatically partition an object that is larger than the printing area supported by a 3D printer and print the partitioned object in 3D.

Another object of the present invention is to automatically arrange partitioned mesh objects in the printing area of a 3D printer in order to reduce the time taken for 3D printing and the amount of material to be used.

A further object of the present invention is to reduce the time taken for 3D printing by decreasing the range within which the head of a 3D printer is required to move in order to perform 3D printing and to save material used for support structures, which are necessary when 3D printing is performed.

In order to accomplish the above objects, a method for printing an object in 3D according to the present invention includes receiving 3D mesh data of the object, determining whether the 3D mesh data is included in a printing area of a 3D printer, generating partitioned mesh objects by partitioning the 3D mesh data if the 3D mesh data is not included in the printing area of the 3D printer, forming a connector for connecting the partitioned mesh objects, arranging the partitioned mesh objects in the printing area, and printing the arranged partitioned mesh objects in 3D.

Generating the partitioned mesh objects by partitioning the 3D mesh data may be configured to generate the partitioned mesh objects such that the 3D mesh data is partitioned by receiving a part to be partitioned from a user, the 3D mesh data is partitioned with exception of a part subjected to a force that is equal or greater than a threshold depending on a result of structural analysis, or the 3D mesh data is partitioned such that a size of the partitioned mesh object is larger than a predetermined size.

The connector may be for connecting a segmented surface of one of the partitioned mesh objects with a segmented surface of another one thereof.

The method for printing an object in 3D further includes converting coordinates of vertices of the partitioned mesh objects arranged in the printing area and storing the converted coordinates. Also, printing the partitioned mesh objects in 3D may be configured to print the partitioned mesh objects using the stored coordinates of the vertices.

If the 3D mesh data is included in the printing area of the 3D printer, the 3D mesh data is not partitioned and may be arranged in the printing area.

If the partitioned mesh object is not capable of being arranged in the printing area, repartitioning the partitioned mesh object may be further included.

Arranging the partitioned mesh objects in the printing area may be configured to rotate or translate each of the partitioned mesh objects in order for the partitioned mesh objects not to collide with each other.

Arranging the partitioned mesh objects in the printing area may comprise determining whether a second partitioned mesh object is capable of being arranged so as to be inserted in a first partitioned mesh object, each of the first and second partitioned mesh objects being one of the partitioned mesh objects, and arranging the first partitioned mesh object and the second partitioned mesh object to internally overlap in the printing area if it is determined that the second partitioned mesh object is capable of being arranged to be inserted in the first partitioned mesh object.

Arranging the partitioned mesh objects in the printing area may be configured to calculate a height of a concave space in the first partitioned mesh object, to calculate a height of the second partitioned mesh object, and to determine whether the second partitioned mesh object is capable of being arranged to be inserted in the first partitioned mesh object by comparing the height of the concave space in the first partitioned mesh object with the height of the second partitioned mesh object.

Arranging the partitioned mesh objects in the printing area may be configured to arrange the multiple partitioned mesh objects having different shapes or the multiple partitioned mesh objects having an identical shape.

Also, a 3D printing apparatus according to an embodiment of the present invention includes an input unit for receiving 3D mesh data of an object to be printed in 3D, a size determination unit for determining whether the 3D mesh data is included in a printing area of the 3D printing apparatus, a mesh partition unit for generating partitioned mesh objects by partitioning the 3D mesh data if the 3D mesh data is not included in the printing area of the 3D printing apparatus, a connector generation unit for forming a connector for connecting the partitioned mesh objects, a printing area arrangement unit for arranging the partitioned mesh objects in the printing area, and a print unit for printing the arranged partitioned mesh objects in 3D.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a 3D printing apparatus according to an embodiment of the present invention;

FIG. 2 is a flowchart illustrating a 3D printing method according to an embodiment of the present invention;

FIG. 3 is a view illustrating the partitioned mesh objects generated at step S230 of FIG. 2;

FIG. 4 is a view illustrating an example of a connector formed in a partitioned mesh object according to an embodiment of the present invention;

FIGS. 5A and 5B are views illustrating a printing area for printing partitioned mesh objects in 3D according to a conventional art;

FIG. 6 is a view illustrating the amount of support material necessary for printing partitioned mesh objects;

FIG. 7 is a view illustrating partitioned mesh objects in quad-tree form;

FIGS. 8A and 8B are views illustrating an example in which partitioned mesh objects collide with each other at step S250 of FIG. 2;

FIGS. 9A and 9B are views illustrating the partitioned mesh objects arranged in a printing area at step S250 of FIGS. 2; and

FIG. 10 is a view illustrating an example of a combination of partitioned mesh objects according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment according to the present invention will be described in detail with reference to the accompanying drawings.

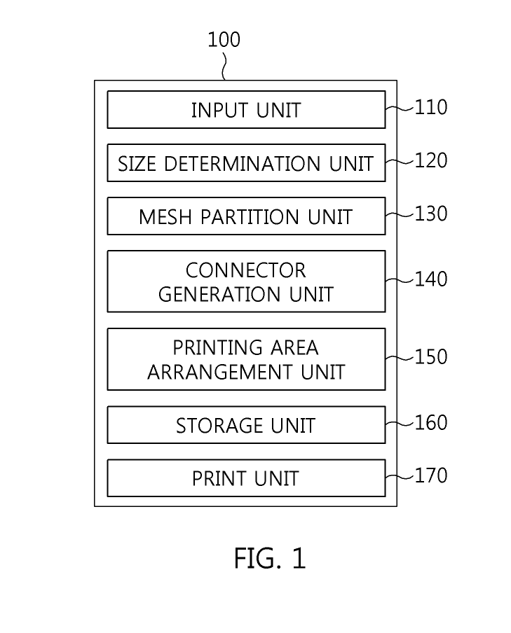

FIG. 1 is a block diagram illustrating the configuration of a 3D printing apparatus according to an embodiment of the present invention.

Referring to FIG. 1, the 3D printing apparatus 100 includes an input unit 110, a size determination unit 120, a mesh partition unit 130, a connector generation unit 140, a printing area arrangement unit 150, a storage unit 160, and a print unit 170.

First, the input unit 110 receives 3D mesh data of an object to be printed in 3D. Here, the 3D mesh data means the 3D shape data of an object to be printed in 3D, and the input unit 110 may load the 3D mesh data from memory, or may receive the 3D mesh data from a user.

The size determination unit 120 determines whether the input 3D mesh data is included in the printing area of a 3D printer. The printing area of the 3D printer means the printable range supported by the 3D printer. When the 3D mesh data has a large size, the 3D printing apparatus 100 cannot print all of the corresponding 3D mesh data in 3D at the same time.

Meanwhile, if the 3D mesh data is included in the printing area of the 3D printer, the 3D printing apparatus 100 does not partition the 3D mesh data. The 3D printing apparatus 100 may arrange the 3D mesh data in the printing area and print it.

If the 3D mesh data is not included in the printing area of the 3D printing apparatus 100, the mesh partition unit 130 generates partitioned mesh objects by partitioning the 3D mesh data.

If the size of the 3D mesh data is larger than the printing area of the 3D printing apparatus 100, the mesh partition unit 130 generates multiple partitioned mesh objects by partitioning the 3D mesh data into objects that are smaller than the printing area in order to enable the 3D printing apparatus 100 to print the partitioned mesh objects in 3D.

Here, the mesh partition unit 130 partitions the 3D mesh data by receiving a part to be partitioned from a user, or partitions the 3D mesh data with exception of a part subjected to force that is equal to or greater than a threshold depending on the result of structural analysis. Alternatively, the mesh partition unit 130 may partition the 3D mesh data such that the size of each of the partitioned mesh objects is larger than a predetermined size in order to facilitate connecting the partitioned mesh objects to form a single object.

The connector generation unit 140 forms a connector for connecting the partitioned mesh objects in the segmented surface of the partitioned mesh object. The connector functions to connect the segmented surface of one of the partitioned mesh objects to the segmented surface of another one. The partitioned mesh objects, after having been printed in 3D, are connected using the connector, whereby shaping of the object corresponding to the 3D mesh data can be completed.

Next, the printing area arrangement unit 150 arranges the partitioned mesh objects in the printing area. Here, the printing area arrangement unit 150 may arrange the partitioned mesh object in the printing area by rotating or translating them such that they do not collide with each other.

If the partitioned 3D mesh data cannot be arranged in the printing area, the mesh partition unit 130 repartitions the partitioned 3D mesh data, and the printing area arrangement unit 150 may arrange the repartitioned mesh objects in the printing area.

Also, the printing area arrangement unit 150 determines whether one of the partitioned mesh objects can be arranged to be inserted in another one. If so, the printing area arrangement unit 150 may arrange the corresponding partitioned objects to internally overlap in the printing area. In this case, the printing area arrangement unit 150 calculates the height of one object to be inserted and the height of the concave space of another object, and may determine whether one object can be arranged to be inserted in another object by comparing the two heights.

The storage unit 160 converts the coordinates of vertices of the partitioned mesh objects arranged in the printing area and stores the converted coordinates.

The print unit 170 prints the partitioned mesh objects, arranged in the printing area, in 3D. Here, the print unit 170 may print the partitioned mesh objects using the coordinates of the vertices stored in the storage unit 160.

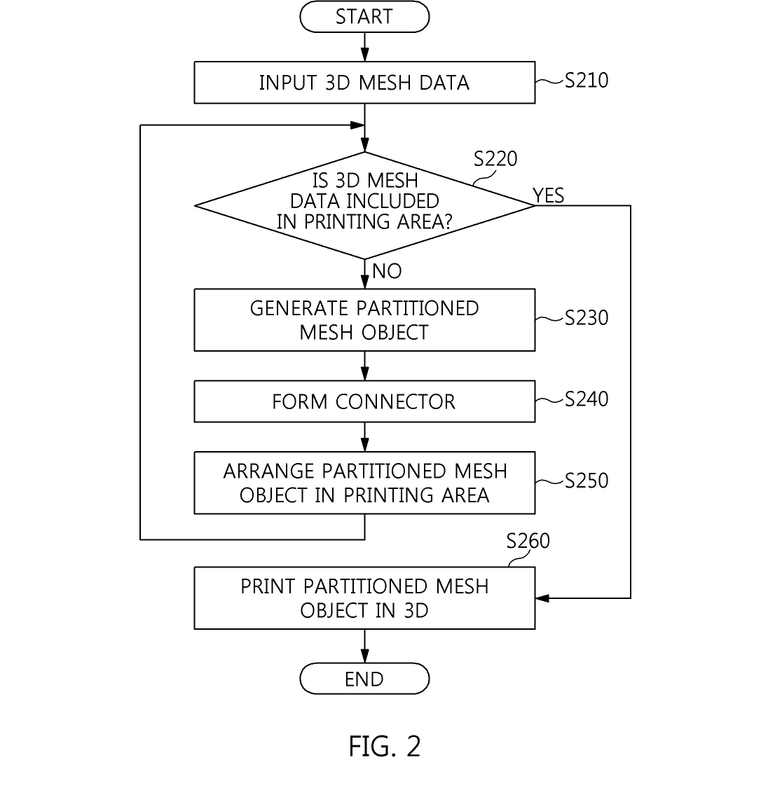

Hereinafter, a 3D printing method according to an embodiment of the present invention will be described in detail with reference to FIGS. 2 to 10,

FIG. 2 is a flowchart illustrating a 3D printing method according to an embodiment of the present invention.

First, the 3D printing apparatus 100 receives 3D mesh data at step S210.

3D mesh data means the 3D shape data of the object to be printed in 3D, and the 3D printing apparatus 100 receives 3D mesh data and prints a 3D object corresponding to the 3D mesh data. Here, the 3D printing apparatus 100 may load the 3D mesh data from memory, or may receive the 3D mesh data from a user.

Then, the 3D printing apparatus 100 determines whether the input 3D mesh data is included in the printing area of the 3D printing apparatus 100 at step S220.

Here, the printing area means the range within which an object can be printed in 3D by moving the print head or the bed plate of the 3D printing apparatus 100. Also, that the 3D mesh data is included in the printing area means that the corresponding 3D mesh data can be printed in 3D without additional preprocessing. Therefore, if the 3D mesh data is included in the printing area, the 3D printing apparatus 100 may skip the process of partitioning the 3D mesh data, and may print the 3D mesh data by performing step S260, which will be described later.

Conversely, if the 3D mesh data is not included in the printing area, the 3D printing apparatus 100 generates partitioned mesh objects by partitioning the 3D mesh data at step S230.

That the 3D mesh data is not included in the printing area means that the size of the object corresponding to the 3D mesh data is larger than the printing area of the 3D printing apparatus 100. In other words, the corresponding 3D mesh data cannot be printed due to the range of movement of the print head or bed plate of the 3D printing apparatus 100. Therefore, the 3D printing apparatus 100 generates partitioned mesh objects having a size that can be included in the printing area by partitioning the 3D mesh data.

The 3D printing apparatus 100 may partition the 3D mesh data into a plurality of partitioned mesh objects by receiving a part to be partitioned from a user to prevent the external appearance of the 3D object from being affected by the partitioned part. Also, the 3D printing apparatus 100 may perform structural analysis and partition the 3D mesh data with exception of a part subjected to force that is equal to or greater than a threshold depending on the result of the analysis.

Also, the 3D printing apparatus 100 may partition the 3D mesh data such that the size of each of the partitioned mesh objects is larger than a predetermined size in order to facilitate the assembly of the partitioned objects when a single 3D object is realized by connecting the multiple partitioned mesh objects printed in 3D. Also, the 3D printing apparatus 100 may partition the 3D mesh data in consideration of the size and area of the connectors in order to enable engagement of the connectors when assembling the partitioned mesh objects using the connectors.

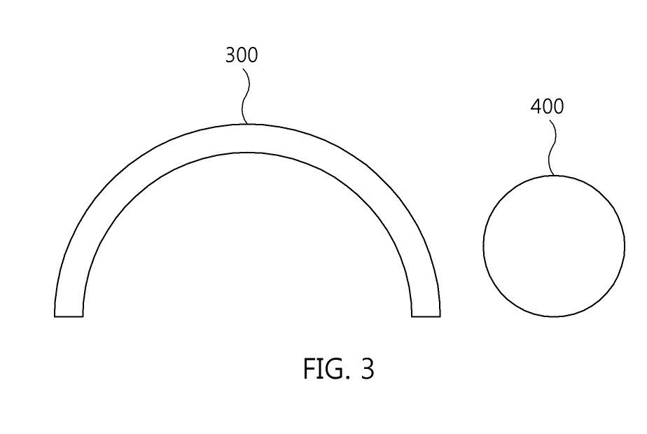

FIG. 3 is a view illustrating the partitioned mesh objects generated at step S230 of FIG. 2.

For example, if the 3D mesh data is a combination of a concave hemisphere and a sphere, the 3D printing apparatus 100 may generate two partitioned mesh objects by partitioning the 3D mesh data into a first partitioned mesh object 300 having the shape of a concave hemisphere and a second partitioned mesh object 400 having the shape of a sphere, as illustrated in FIG. 3.

Also, the 3D printing apparatus 100 forms a connector for connecting the multiple partitioned mesh objects at step S240.

Here, the connector is for connecting the partitioned mesh objects, and may have various shapes such as a cylinder, a faceted cylinder, a rectangular parallelepiped, and the like. Also, the connector may be made of magnetic material, and the size thereof may be smaller than that of each of the partitioned mesh objects.

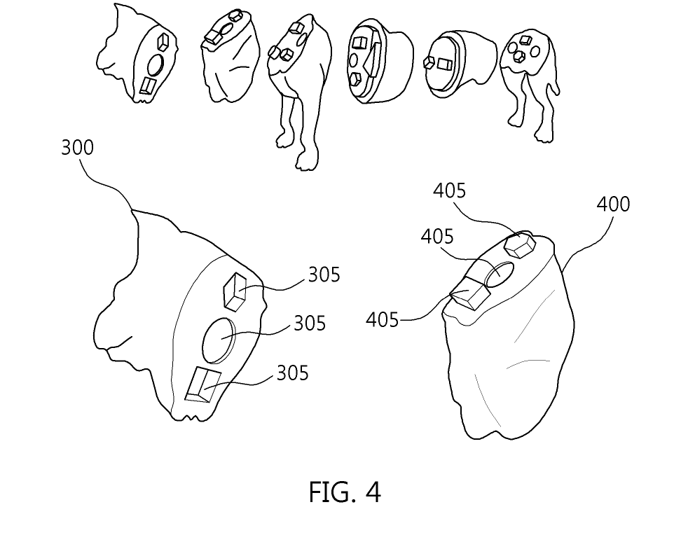

FIG. 4 is a view illustrating an example of a connector formed in a partitioned mesh object according to an embodiment of the present invention.

As illustrated in FIG. 4, a first connector 305 in the segmented surface of the first partitioned mesh object 300 and a second connector 405 in the segmented surface of the second partitioned mesh object 400 are formed to have symmetrical shapes at symmetrical locations. Also, the first partitioned mesh object 300 and the second partitioned mesh object 400 may be assembled into a single object by engaging the first connector 305 and the second connector 405.

For the convenience of description, the process in which the 3D printing apparatus 100 generates the partitioned mesh objects is described as being separate from the process of forming the connectors in the partitioned mesh objects, but without limitation to this, step S230 and step S240 may be performed as a single process.

Next, the 3D printing apparatus 100 arranges the partitioned mesh objects in the printing area at step S250. Here, the partitioned mesh objects, arranged in the 3D printing area, are the partitioned mesh objects in which the connector is formed at step S240.

For the convenience of description, the case in which the 3D printing apparatus 100 arranges the partitioned mesh objects in the printing area is explained. However, without limitation to this case, if the size of the 3D mesh data input at step S210 is smaller than the printing area and multiple pieces of 3D mesh data can be arranged in the printing area, the 3D printing apparatus 100 according to an embodiment of the present invention may arrange the multiple pieces of 3D mesh data in the printing area and print them at once.

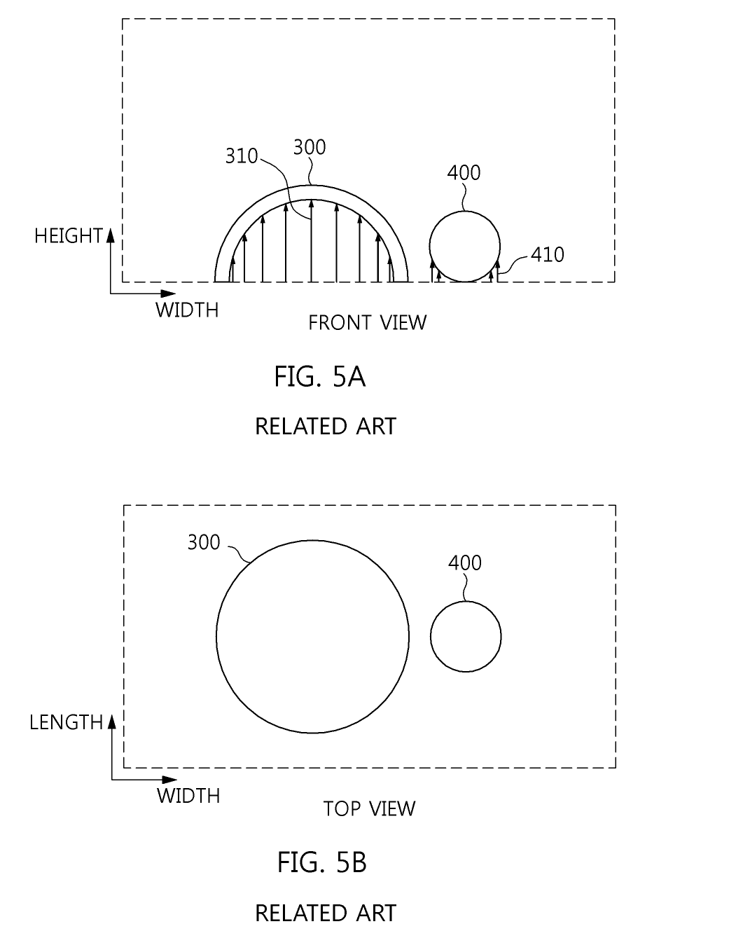

FIGS. 5A and 5B are views illustrating a printing area for printing partitioned mesh objects in 3D according to the conventional art.

As illustrated in FIGS. 5A and 5, according to the conventional art, the first partitioned mesh object 300 and the second partitioned mesh object 400 having the shape of a sphere are arranged in a row without regard to spatial arrangement and are printed in 3D.

Here, as illustrated in the front view of FIG. 5A, a section that ranges from the bed plate to the height 310 of the underside of the first partitioned mesh object 300 and a section that ranges from the bed plate to the height 410 of the underside of the second partitioned mesh object 400 must be filled with support structures. Accordingly, when the spatial arrangement is not considered, a large amount of material must be used for the support structures.

Also, because the range within which the print head is required to move must be widened in order to enable the 3D printing apparatus 100 to print the object in 3D as shown in the top view of FIG. 5B, it takes a lot of time for 3D printing.

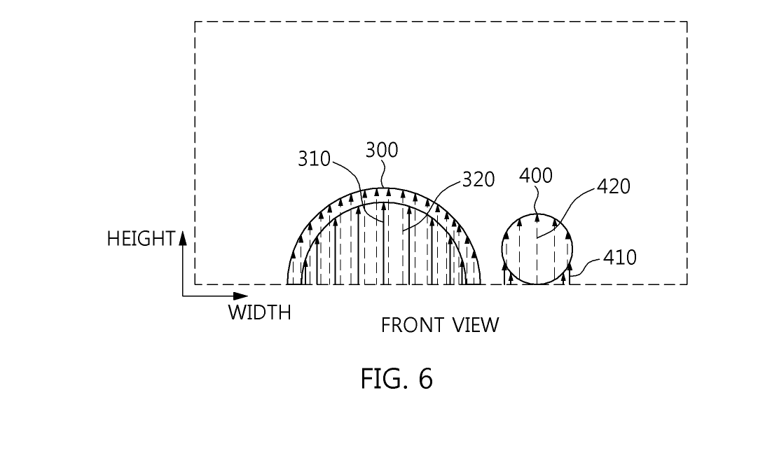

FIG. 6 is a view illustrating the amount of support material necessary for printing the partitioned mesh objects.

As illustrated in the cross-sectional view of FIG. 6, when the partitioned mesh objects to be printed in 3D are arranged in the printing area of the 3D printing apparatus 100, the amount of material for support structures to be used may be represented using the height of the partitioned mesh object at each point in the cross section of the object. The first partitioned mesh object 300 needs a support structure corresponding to the height 310 of the underside thereof at each point, and the second partitioned mesh object 400 needs a support structure corresponding to the height 410 of the underside thereof at each point.

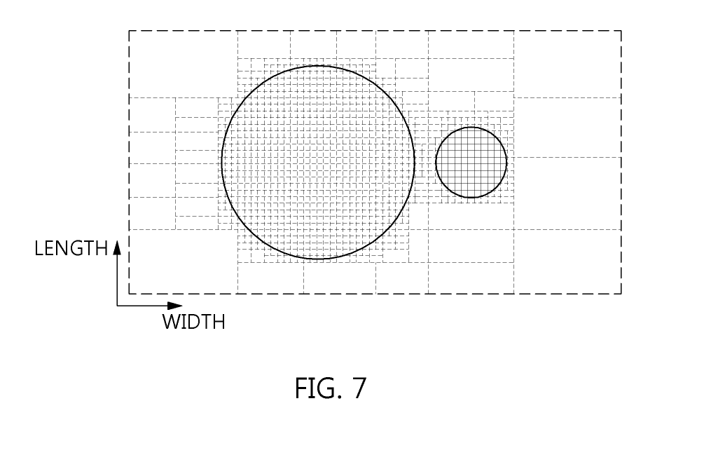

FIG. 7 is a view illustrating the partitioned mesh objects in quad-tree form.

As illustrated in FIG. 7, the cross sections of the partitioned mesh objects are divided into cells having a normalized size, and a height may be specified for each of the cells. As shown in FIG. 7, when the cross section of the partitioned mesh object is represented in the quad-tree form, information about the partitioned mesh objects may be stored using less memory. In this case, the nodes corresponding to the cells in which the partitioned mesh object is located have the same depth in the quad-tree in order to leave the area of the nodes of the quad-tree out of consideration.

For each terminal node of the quad-tree, a height value may be represented as the height of an upper part and the height of a lower part, and the height of an upper part and the height of a lower part may comprise multiple values. Also, the height of an upper part and the height of a lower part are always represented as an ordered pair. In other words, if there are a plurality of upper part heights and lower part heights for one terminal node, they are always arranged in the form of ordered pairs when they are sorted in descending order.

Meanwhile, when the 3D printing apparatus 100 arranges multiple partitioned mesh objects in the printing area, the partitioned mesh objects may collide with each other.

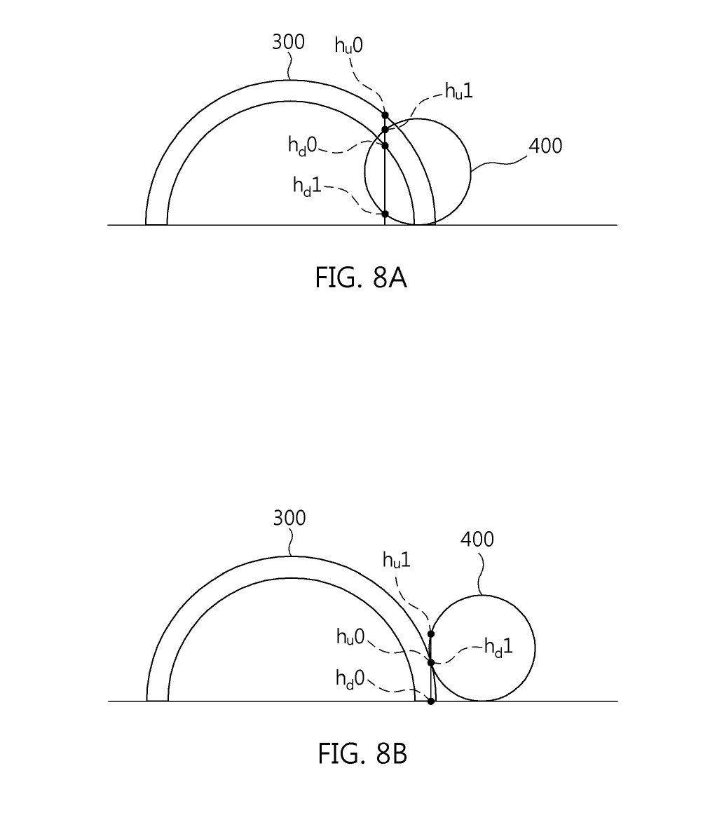

FIGS. 8A and 8B illustrate an example in which partitioned mesh objects collide with each other at step S250 of FIG. 2.

As illustrated in FIG. 8A, for the ordered pair (hᵤ₀, h_{d0}) that consists of the height of the upper part hᵤ₀ and the height of the lower part h_{d0} of the first partitioned mesh object 300 and the ordered pair (hᵤ₁, h_{d1}) that consists of the height of the upper part hᵤ₁ and the height of the lower part h_{d1} of the second partitioned mesh object 400, if the heights are sorted in descending order, they are arranged as hᵤ₀, hᵤ₁, h_{d0}, and h_{d1}. In this case, because the heights are not arranged as the ordered pairs of the first partitioned mesh object 300 and the second partitioned mesh object 400, the 3D printing apparatus 100 according to an embodiment of the present invention determines that the first partitioned mesh object 300 will collide with the second partitioned mesh object 400.

Also, as illustrated in FIG. 8B, if the height of the upper part hᵤ₀ of the first partitioned mesh object 300 is the same as the height of the lower part h_{d1} of the second partitioned mesh object 400, the 3D printing apparatus 100 determines that the first partitioned mesh object 300 and the second partitioned mesh object 400 abut each other, and thus collide with each other.

When the partitioned mesh objects collide with each other as illustrated in FIGS. 8A and 8B, the 3D printing apparatus 100 according to an embodiment of the present invention may rearrange the partitioned mesh objects 300 and 400 by rotating or translating them so that they do not collide with each other, or may further perform a step of repartitioning the partitioned mesh objects 300 and 400.

Also, because the 3D printing method according to an embodiment of the present invention arranges the partitioned mesh objects at the optimum location in the printing area, the objects may be printed in 3D using a small amount of material for support structures, and the time required for 3D printing may be reduced.

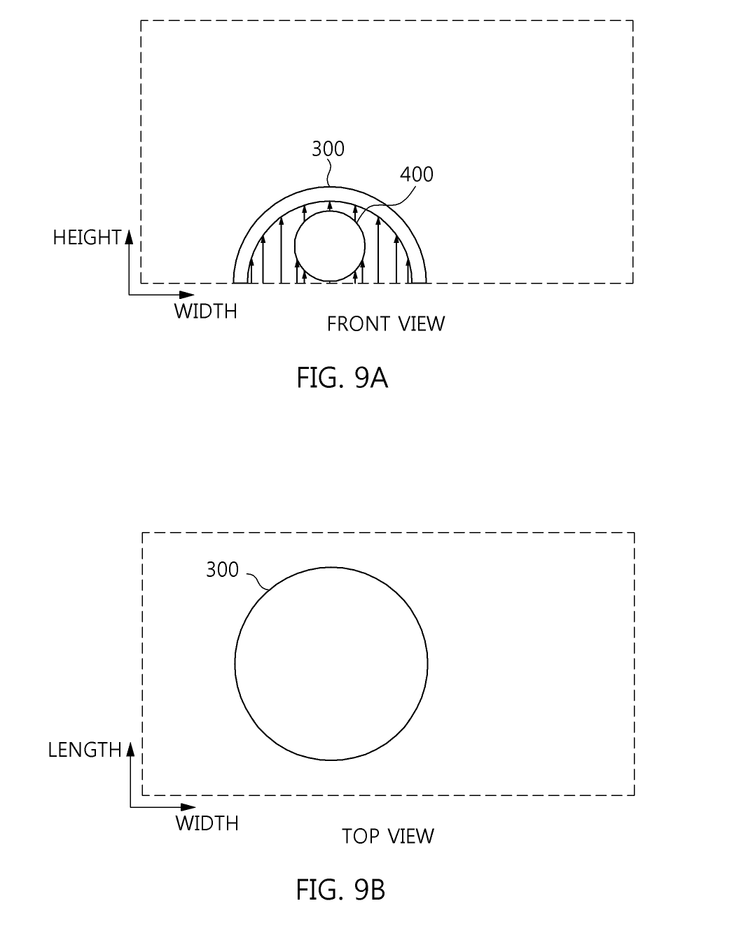

FIGS. 9A and 9B are views illustrating the partitioned mesh objects arranged in the printing area at step S250 of FIG. 2.

As illustrated in the front view of FIG. 9A, if the second partitioned mesh object 400 can be arranged to be inserted in the first partitioned mesh object 300, the first partitioned mesh object 300 and the second partitioned mesh object 400 are arranged to internally overlap in the printing area.

Here, that the second partitioned mesh object 400 can be arranged to be inserted in the first partitioned mesh object 300 means that the size and volume of the hollow space in the first partitioned mesh object 300 are greater than the size and volume of the second partitioned mesh object 400, and thus the second partitioned mesh object 400 can be arranged to be located in the concave space in the first partitioned mesh object 300.

Also, arranging the partitioned mesh objects to internally overlap in the printing area means that the object may be depicted as internally overlapping in any one of the front view and the top view. In this case, the partitioned mesh objects 300 and 400 must be arranged no as not to partially overlap each other and not to collide with each other.

The 3D printing apparatus 100 according to an embodiment of the present invention calculates the height of the concave space in the first partitioned mesh object 300 and the height of the second partitioned mesh object 400, compares the calculated heights, and determines whether the second partitioned mesh object 400 may be arranged to be inserted in the concave space in the first partitioned mesh object 300.

The height 310 of the underside of the first partitioned mesh object 300 and the height 420 of the second partitioned mesh object 400, illustrated in FIG. 6, are compared, and if the height 310 of the underside of the first partitioned mesh object 300 is greater than the height 420 of the second partitioned mesh object 400, and if the volume of the concave space, calculated using the height 310 of the underside of the first partitioned mesh object 300, is greater than the volume of the second partitioned mesh object 400, the 3D printing apparatus 100 may determine that the second partitioned mesh object 400 can be arranged to be inserted in the first partitioned mesh object 300.

When it is determined that the second partitioned mesh object 400 can be arranged to be inserted in the first partitioned mesh object 300, the first partitioned mesh object 300 and the second partitioned mesh object 400 can be arranged in the printing area as shown in FIGS. 9A and 9B. As illustrated in the front view of FIG. 9A, the second partitioned mesh object 400 can be arranged in the concave space in the first partitioned mesh object 300. Accordingly, the range to which the 3D printing apparatus 100 is required to move for 3D printing may be decreased as shown in FIG. 9B, and thus the time taken for 3D printing may also be reduced.

Also, the 3D printing apparatus 100 may further perform a step of converting the coordinates of the vertices of the partitioned mesh objects 300 and 400, arranged in the printing area, and storing the converted coordinates.

Then, the 3D printing apparatus 100 performs step S220 again to check whether the partitioned mesh objects arranged in the printing area are included in the printing area.

Finally, if the partitioned mesh objects arranged in the printing area are included in the printing area, the 3D printing apparatus 100 prints the partitioned mesh objects in 3D at step S260. Here, the 3D printing apparatus 100 may print the partitioned mesh objects using the stored coordinates of the vertices of the partitioned mesh objects 300 and 400.

Then, the multiple partitioned mesh objects 300 and 400, printed in 3D at step S260, may be connected using connectors, and thus a 3D object corresponding to the 3D mesh data may have a complete shape.

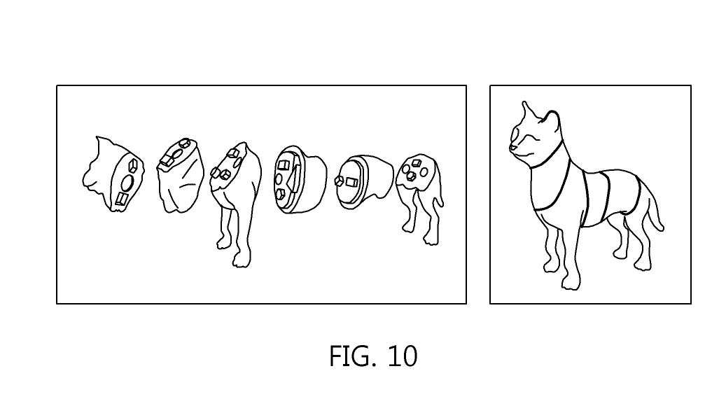

FIG. 10 is a view illustrating an example for explaining a combination of partitioned mesh objects according to an embodiment of the present invention.

As illustrated in FIG. 10, the multiple partitioned mesh objects are assembled into a single 3D object in such a way that one of the multiple partitioned mesh objects is connected to another using connectors formed in one or more segmented surfaces of the objects.

According to the present invention, an object that is larger than the printing area supported by a 3D printer may be automatically partitioned and printed in 3D.

Also, the present invention automatically arranges partitioned mesh objects in the printing area of a 3D printer, whereby the time taken for 3D printing may be reduced and the amount of material to be used may be reduced.

Also, the present invention decreases the range within which the head of a 3D printer is required to move, whereby the time taken for 3D printing may be reduced and the amount of material for support structures may be reduced.

As described above, a 3D printing apparatus and method according to the present invention are not limitedly applied to the configurations and operations of the above-described embodiments, but all or some of the embodiments may be selectively combined and configured so that the embodiments may be modified in various ways.

What is claimed is:

1. A 3D printing method for printing an object in 3D, comprising:
receiving 3D mesh data of the object;
determining whether the 3D mesh data is included in a printing area of a 3D printer;
generating partitioned mesh objects by partitioning the 3D mesh data if the 3D mesh data is not included in the printing area of the 3D printer;
forming a connector for connecting the partitioned mesh objects;
arranging the partitioned mesh objects in the printing area; and
printing the arranged partitioned mesh objects in 3D.

2. The 3D printing method of claim 1, wherein generating the partitioned mesh objects by partitioning the 3D mesh data is configured to generate the partitioned mesh objects such that,
the 3D mesh data is partitioned by receiving a part to be partitioned from a user,
the 3D mesh data is partitioned with exception of a part subjected to a force that is equal to or greater than a threshold depending on a result of structural analysis, or
the 3D mesh data is partitioned such that a size of the partitioned mesh object is larger than a predetermined size.

3. The 3D printing method of claim 1, wherein the connector is for connecting a segmented surface of one of the partitioned mesh objects with a segmented surface of another one thereof.

4. The 3D printing method of claim I, further comprising,
converting coordinates of vertices of the partitioned mesh objects arranged in the printing area and storing the converted coordinates,
wherein printing the partitioned mesh objects in 3D is configured to print the partitioned mesh objects using the stored coordinates of the vertices.

5. The 3D printing method of claim 1, wherein if the 3D mesh data is included in the printing area of the 3D printer, the 3D mesh data is not partitioned and is arranged in the printing area.

6. The 3D printing method of claim 1, further comprising,
repartitioning the partitioned mesh object if the partitioned mesh object is not capable of being arranged in the printing area.

7. The 3D printing method of claim 1, wherein arranging the partitioned mesh objects in the printing area is configured to rotate or translate each of the partitioned mesh objects in order for the partitioned mesh objects not to collide with each other.

8. The 3D printing method of claim 1, wherein arranging the partitioned mesh objects in the printing area comprises:
determining whether a second partitioned mesh object is capable of being arranged so as to be inserted in a first partitioned mesh object, each of the first and second partitioned mesh objects being one of the partitioned mesh objects; and
arranging the first partitioned mesh object and the second partitioned mesh object to internally overlap in the printing area if it is determined that the second partitioned mesh object is capable of being arranged to be inserted in the first partitioned mesh object.

9. The 3D printing method of claim 8, wherein arranging the partitioned mesh objects in the printing area is configured to:
calculate a height of a concave space in the first partitioned mesh object;
calculate a height of the second partitioned mesh object; and
determine whether the second partitioned mesh object is capable of being arranged to be inserted in the first partitioned mesh object by comparing the height of the concave space in the first partitioned mesh object with the height of the second partitioned mesh object.

10. The 3D printing method of claim 1, wherein arranging the partitioned mesh objects in the printing area is configured to arrange the multiple partitioned mesh objects having different shapes or the multiple partitioned mesh objects having an identical shape.

11. A 3D printing apparatus, comprising:
an input unit for receiving 3D mesh data of an object to be printed in 3D;
a size determination unit for determining whether the 3D mesh data is included in a printing area of the 3D printing apparatus;
a mesh partition unit for generating partitioned mesh objects by partitioning the 3D mesh data if the 3D mesh data is not included in the printing area of the 3D printing apparatus;
a connector generation unit for forming a connector for connecting the partitioned mesh objects;
a printing area arrangement unit for arranging the partitioned mesh objects in the printing area; and
a print unit for printing the arranged partitioned mesh objects in 3D.

12. The 3D printing apparatus of claim 11, wherein the mesh partition unit generates the partitioned mesh objects by partitioning the 3D mesh data by receiving a part to be partitioned from a user, by partitioning the 3D mesh data with exception of a part subjected to a force that is equal to or greater than a threshold depending on a result of structural analysis, or by partitioning the 3D mesh data such that a size of the partitioned mesh object is larger than a predetermined size.

13. The 3D printing apparatus of claim 11, wherein the connector is for connecting a segmented surface of one of the partitioned mesh objects with a segmented surface of another one thereof.

14. The 3D printing apparatus of claim 11, further comprising,
a storage unit for converting coordinates of vertices of the partitioned mesh objects arranged in the printing area and storing the converted coordinates,
wherein the print unit prints the partitioned mesh objects using the stored coordinates of the vertices.

15. The 3D printing apparatus of claim 11, wherein if the 3D mesh data is included in the printing area of the 3D printing apparatus, the 3D mesh data is not partitioned, and is arranged in the printing area.

16. The 3D printing apparatus of claim 11, wherein the mesh partition unit repartitions the partitioned mesh object if the partitioned mesh object is not capable of being arranged in the printing area.

17. The 3D printing apparatus of claim 11, wherein the printing area arrangement unit rotates or translates each of the partitioned mesh objects in order for the partitioned mesh objects not to collide with each other.

18. The 3D printing apparatus of claim 11, wherein the printing area arrangement unit determines whether a second partitioned mesh object is capable of being arranged to be inserted in a first partitioned mesh object, and arranges the first partitioned mesh object and the second partitioned mesh object to internally overlap in the printing area if it is determined that the second partitioned mesh object is capable of being arranged to be inserted in the first partitioned mesh object, each of the first and second partitioned mesh objects being one of the partitioned mesh objects.

19. The 3D printing apparatus of claim 18, wherein the printing area arrangement unit calculates a height of a concave space in the first partitioned mesh object, calculates a height of the second partitioned mesh object, and determines whether the second partitioned mesh object is capable of being arranged to be inserted in the first partitioned mesh object by comparing the height of the concave space in the first partitioned mesh object with the height of the second partitioned mesh object.

20. The 3D printing apparatus of claim 11, wherein the printing area arrangement unit arranges the multiple partitioned mesh objects having different shapes or the multiple partitioned mesh objects having an identical shape.
